(19) United States
(12) Patent Application Publication
(10) Pub. No.: US 2019/0271643 A1
(43) Pub. Date: Sep. 5, 2019

(54) Refractometer and Method for Determining Dynamic Properties of a Sample

(71) Applicant: Anton Paar Opto Tec GmbH, Seelze (DE)

(72) Inventors: Sarah Schwarz Goncalves Henriques, Peine (DE); Martin Ostermeyer, Gehrden (DE)

(73) Assignee: Anton Paar Opto Tec GmbH, Seelze (DE)

(21) Appl. No.: 16/344,296

(22) PCT Filed: Oct. 11, 2017
(86) PCT No.: PCT/EP2017/075928

§ 371 Date: Apr. 23, 2019

(30) Foreign Application Priority Data
Oct. 25, 2016 (DE) 10 2016 120 377.7

(51) Int. Cl. G01N 21/41; G01N 21/17

(52) U.S. Cl. CPC G01N 21/4133; G01N 21/1717

(57) ABSTRACT

The invention relates to a refractometer (2) and a method for measuring properties of a sample by means of the refractometer, the refractometer includes a measuring body (4) having a measuring surface (4.1), a measuring chamber (6) delimited by the measuring surface (4.1) of the measuring body (4) for receiving a sample (8) and an optical measuring device (10) for measuring the refractive index of the sample (8) by the measuring body (4). The measuring chamber (6) is designed to be able to stress the sample (8) mechanically by means of a pressure and/or force modulation in order to measure the refractive index n of the sample dynamically during the modulation.

### TECHNICAL FIELD

The invention is directed to the field of measurement of dynamic properties of a sample, in particular via the measurement of the refractive index by means of a refractometer.

### BACKGROUND

Patent document EP 2 266 693 A1 discloses a refractometer having a housing, a measuring cell arranged in the housing and a cover unit which has a base plate with a recess which forms an access to the measuring cell of the refractometer, and a cover for covering the measuring cell. The cover is attached to the base plate via a hinge. The cover unit further has a cover insert which is removably arranged in the cover, and the cover unit is detachably connected to the housing via a connecting element connected to the base plate. The detachable cover unit with the removable cover insert facilitates the cleaning of the measuring cell and also makes it possible to condition the measuring cell, for example by temperature conditioning. The determined data of the sample are static and limited to the refractive index.

The patent document WO 2012/025346 A1 relates to a temperature-modulated refractive index measurement by a refractometer with a measuring prism. The complex temperature coefficient of the refractive index of the sample is based on a refractive index measurement. The refractive index of the sample is measured over a period of time, whereby the temperature of the sample is modulated over time, and the complex temperature coefficient of the refractive index is calculated based on the refractive index measurement and the temperature modulation over time. This teaching only concerns a temperature-modulated refractive index measurement.

The document U.S. Pat. No. 4,702,604 relates to a method and apparatus for accurately determining the compressibility of a gaseous sample. Two grating interferometers are coupled together, with one interferometer providing a signal with refractive index information of the gas sample, and the other interferometer providing a different signal with information about the pressure of the gas sample, thereby enabling measurement of refractive index as a function of pressure. However, this is limited to gases and requires a complex and expensive system.

### SUMMARY OF THE INVENTION

### Technical Problem

The object of the invention is to resolve at least one problem of the above-cited prior art. In particular, the object of the invention is to determine dynamic properties of a material or a sample by a simple way.

### Technical Solution

The invention consists of a refractometer comprising a measuring body with a measuring surface; a measuring chamber delimited by the measuring surface of the measuring body for receiving a sample; an optical measuring device for measuring the refractive index of the sample by the measuring body; wherein the measuring chamber is designed to be able to stress the sample mechanically by a pressure and/or force modulation in order to measure the refractive index n of the sample dynamically during the modulation.

The measuring body may consist of a material that is wholly or partially transparent, preferably in a given wavelength range.

The sample may be solid, gel and/or paste-like or liquid.

The temperature of the sample can also be modulated during the pressure and/or force modulation.

The measuring body may be a measuring prism.

In a further embodiment, the measuring chamber is designed such that the pressure and/or force modulation is oscillating, preferably according to a periodic function.

In a further embodiment, the measuring chamber is gas tightly lockable, wherein the refractometer comprises a pressure control device for modulating the pressure of a gas in the measuring chamber.

In a further embodiment, the pressure control device comprises a first electrically controllable valve which connects a gas supply with the measuring chamber, and a second electrically controllable valve which connects the measuring chamber with the environment.

In a further embodiment, the pressure control device comprises a pressure regulator for modulating the pressure of a gas in the measuring chamber.

In a further embodiment, the measuring chamber comprises an ultrasonic transducer for modulating the pressure on the sample.

In a further embodiment, the measuring chamber comprises a force and/or feed control device with a punch and at least one actuator for actuating the punch against the sample.

In a further embodiment, the actuator is designed to operate electrically, electro-magnetically, hydraulically and/or pneumatically.

In a further embodiment, the force and/or feed control device comprises a sensor for measuring the force exerted by the punch on the sample and/or a sensor for measuring the displacement of the punch.

In a further embodiment, the force and/or feed control device is designed such that the force exerted by the punch on the sample is not parallel to the longitudinal axis of the punch.

In a further embodiment, the force control device is designed such that the force exerted by the punch on the sample force is rotating about the longitudinal axis of the punch.

In a further embodiment, the refractometer comprises an evaluation unit which is designed such that it determines the compressibility k of the sample based on the measurement of the refractive index during the force and/or pressure modulation.

The invention also consists of a method of measuring properties of a sample comprising the steps of: introducing a sample into a refractometer; measuring the refractive index of the sample with the refractometer, wherein the refractometer is according to the invention; the sample is stressed by a modulated force and/or a modulated pressure during the refractive index measurement, and the refractive index n is determined dynamically as a function of the pressure and/or force modulation.

In a further embodiment, the dynamic compressibility k of the sample is determined on the basis of the dynamic refractive index n using an optomechanical model, preferably the Lorentz-Lorenz equation. The optomechanical model establishes relationships between refractive index, density and refractivity. The optomechanical model may include for example the relations to Gladstone-Dale, Beysens and/or Proutiere.

In a further embodiment, the density p of the sample is determined during the pressure and/or force modulation on the basis of the displacement or the volume change due to the pressure and/or force modulation.

In a further embodiment, the dynamic specific refractivity r of the sample is determined on the basis of the dynamic refractive index n and the density ρ using an optomechanical model, preferably the Lorentz-Lorenz equation. The optomechanical model establishes relationships between refractive index, density and refractivity. The optomechanical model may include for example the relations to Gladstone-Dale, Beysens and/or Proutiere.

In a further embodiment, a chemical reaction, preferably a polymerization reaction, and/or a swelling and/or aging and/or a phase or glass transition during the measurement of the refractive index takes place in the sample, and the change of the dynamic specific refractivity r of the sample provides microscopic information and changing the density ρ of the sample provides macroscopic information.

In a further embodiment, a gelling transition takes place in the sample during the measurement of the refractive index and the pressure and/or force modulation comprises a modulated shearing oscillation and/or a modulated rotational oscillation.

In another embodiment, one or more signals reflecting the shape of the refractive index n, the density ρ and/or the specific refractivity r are demodulated, and a peak in the imaginary part of the demodulation is observed and correlated with the transition.

In a further embodiment, the optical measuring device selectively emits and/or detects s- or p-polarized beams for measuring anisotropy in the sample.

### Advantages of the Invention

The mechanical properties of the sample and their temporal changes are measurable thanks to the invention. The invention is also particularly suitable for samples in which the usual measuring methods fail. The modulated measurement also allows for slow processes, such as aging processes, or to monitor chemical changes of samples (e.g. adhesive). The dynamic compressibility determined with the pressure-modulated refractive index measurement is distinguished from the static compressibility of the equilibrium or reversible thermodynamics in that it produces information about temporal phenomena of irreversible thermodynamics. The modulated measurement allows macroscopic as well as microscopic, dynamic information on the sample to be collected.

### BRIEF DESCRIPTION OF THE DRAWINGS

FIG. 1 shows a schematic plan view of a refractometer according to a first embodiment of the invention.

FIG. 2 shows a schematic plan view of a measuring chamber of a refractometer according to a second embodiment of the invention.

FIG. 3 shows a schematic plan view of a refractometer according to a third exemplary embodiment of the invention.

FIG. 4 shows a schematic plan view of a measuring chamber of a refractometer according to a fourth embodiment of the invention.

### DESCRIPTION OF THE EMBODIMENTS

FIG. 1 shows schematically the structure of a refractometer according to a first embodiment of the invention. The refractometer 2 has a measuring body 4, a measuring chamber 6, an optical measuring device 10 and a pressure control device 12. The measuring body 4 preferably consists of a material which is completely or partially transparent in the wavelength range used. The wavelength range may include, for example, the infrared and/or visible and/or ultraviolet spectral range. The measuring body 4 is a measuring prism in the present case. However, it is obvious to those skilled in the art that other geometries, for instance hemispheres and cylinders are possible.

The measuring prism 4 comprises a measuring surface 4.1, which delimits the measuring chamber 6. A sample 8 is placed on the measuring surface 4.1 in the measuring chamber. The sample may be solid, gel and/or paste-like or liquid. The measuring chamber 6 can be closed and sealed. A gas fills the measuring chamber 6 and forms the immediate environment of the sample. The pressure of the gas is modulated by the pressure controller 12. For example, the pressure control device 12 has a first valve 12.1, which is in communication with a gas supply 12.2, and a second valve 12.3, which is in direct communication with the external environment. The gas supply 12.2 is shown schematically. For example, it may have a cylinder filled with gas under high pressure and possibly a pressure reducer connected to the outlet of the bottle. By an appropriate cyclical control of the first and second valves 12.1 and 12.3, the measuring chamber 6 and therefore the sample 8 can be subjected to a variable pressure. The first valve 12.1 can be opened while the second valve 12.3 is closed. The pressure in the measuring chamber 6 therefore increases up to the pressure level of the gas supply. The first valve 12.1 can then be closed and the second valve 12.3 can be opened so that the pressure in the measuring chamber 6 decreases. This can be done cyclically so that the sample 8 is stressed by a modulated pressure. The amplitude of the pressure change may for example be in a range of 50-1000 mbar.

The measuring chamber 6 may include a pressure sensor 14 for measuring the pressure in the chamber. The control unit 16 is connected to the pressure control device 12 for controlling the pressure modulation in the chamber.

The optical measuring device 10 comprises a light source 10.1, a detector 10.2, a control and/or regulating unit 10.3 and an interpreting device 10.4. The optical measuring device 10 can also have a focusing optics and optionally polarizers between the light source 10.1 and the input surface 4.2 of the measuring prism. The same applies to the optical path between the output surface 4.3 of the measuring prism and the detector 10.2. The control and/or regulating unit 10.3 and the interpreting device 10.4 can be connected to an internal or external evaluation unit 18. This evaluation unit 18 is also connected to the control unit 16 of the pressure control device 12.

The construction of the optical measuring device 10 described above is well known to those skilled in the art and therefore need not be further detailed.

Since the refractive index of the sample is measured relative to that of the measuring prism, it is necessary to know well the properties of the prism (refractive index, pressure or force behaviour, etc.) in order to make the dynamic properties of the samples measurable. In addition to the preferred measurement of the refractive index in total reflection, the refractive index measurement can be realized in a measurement setup with transmission geometry.

In the refractometer described above, the sample is mechanically stressed during the refractive index measurement by a pressure modulation. By modulation is meant in the most general form a periodic change of a quantity. The modulation may be varied and may, for example, have a rectangular, triangular, sinusoidal or polynomial time course or combinations thereof. The pressure control device described above is more suitable for rectangular modulation. Instead of two valves that can only be opened and closed, the pressure control device may have a controlled pressure regulator that can generate any modulations.

By means of the relation between the refractive index n and the density ρ, in the case of a pressure modulation, the dynamic compressibility k is obtained as a new material property measurable with a refractometer. In a simple, theoretical model, for example the Lorentz-Lorenz relation

$$\frac{{n}^{2} - 1}{{n}^{2} + 2} = r \cdot ρ$$

is based on the specific refractivity r. Assuming, moreover, that the specific refractivity r hardly depends on the pressure/force, and therefore

$$\frac{\partial r}{\partial p} = 0 ,$$

we obtain from the partial derivation of the Lorentz-Lorenz relation for compressibility the formula

$$k = \frac{1}{ρ} \cdot \frac{\partial ρ}{\partial p} = \frac{6 \cdot n}{( {n}^{2} - 1 ) \cdot ( {n}^{2} + 2 )} \cdot \frac{\partial n}{\partial p} ≅ \frac{6 \cdot 〈 n 〉}{( {〈 n 〉}^{2} - 1 ) \cdot ( {〈 n 〉}^{2} + 2 )} \cdot \frac{\partial n}{\partial p} .$$

In complex notation, the equation is

$${k}^{*} = \frac{6 \cdot 〈 n 〉}{( {〈 n 〉}^{2} - 1 ) \cdot ( {〈 n 〉}^{2} + 2 )} \cdot \frac{\partial {n}^{*}}{\partial p} .$$

In this case, [symbol] n [symbol] is to be understood as the refractive index averaged over a modulation period. A separate density measurement is not necessary, but can optionally be done to obtain more accurate measurement results. Instead of the Lorentz-Lorenz relation, another comparable optomechanical model can be used. These comparable optomechanical models all produce relationships between refractive index, density, and refractivity, and include the method of deriving the respective formulas for a thermo-optical model, i.e. by deriving the underlying equations relative to the pressure and/or force for the relationship between compressibility and refractive index. Optomechanical models known to the person skilled in the art are, for example, the relations according to Gladstone-Dale, Beysens or Proutiere.

In more general case that the specific refractivity r is dependent on pressure or force, e.g. in a simple model after derivation of the Lorentz-Lorenz relation of the context in complex notation:

$$\frac{6 \cdot 〈 n 〉}{( {〈 n 〉}^{2} - 1 ) \cdot ( {〈 n 〉}^{2} + 2 )} \cdot \frac{\partial {n}^{*}}{\partial p} = {( \frac{1}{r} \cdot \frac{\partial r}{\partial p} )}^{*} + {( \frac{1}{ρ} \cdot \frac{\partial ρ}{\partial p} )}^{*} = {( \frac{1}{r} \cdot \frac{\partial r}{\partial p} )}^{*} + {k}^{*} .$$

Thus, with the pressure-modulated refractive index measurement, information can be obtained not only about the compressibility but also about the pressure dependence of the specific refractivity r. This is advantageous, in particular in the case of known compressibility, since the specific refractivity is dependent on intermolecular bonds and thus provides information on microscopic correlations.

With continuous measurement of the refractive index is a sample of a known mechanical oscillating excitation, hereinafter with

p(t,ω)=pₐₘₚₗ·f(ω,t)+ [symbol] p

[symbol]

where t represents time and f(ω,t) represents a periodic function, sin(ωt) in the simplest case. The measurement duration must include at least one modulation period of the pressure/force modulation. It can also include several modulation periods. The mean mechanical change/control variable [symbol] p [symbol] can be kept constant during its modulation or, according to a predetermined program, for example, be changed linearly and is thus time-dependent.

When mechanical excitation, an isotropic or directional pressure/force or deformation modulation can be applied, the application of modulated torsional forces or rotational deformations is also conceivable. Selecting a small amplitude pₐₘₚₗ results in a linear response in the refractive index n=

$$〈 n 〉 + \vert \frac{\partial {n}^{*}}{\partial p} \vert \cdot {p}_{ampl} \cdot sin ( ω t - φ ) .$$

Here, [symbol] n [symbol] is the mean refractive index (measured over a period) and ϕ the phase shift between refractive index and pressure/force modulation. From this signal, the complex optomechanical coefficient

$$\frac{{dn}^{*}}{dp} = \vert \frac{\partial {n}^{*}}{\partial p} \vert {e}^{- i φ}$$

can then be determined by demodulation.

The dynamic compressibility determined with the pressure-modulated refractive index measurement is distinguished from the static compressibility of the equilibrium or reversible thermodynamics in that it reproduces information about temporal phenomena of irreversible thermodynamics. This is in real applications of particular interest because, for example, a stress on a material is typically not in thermal equilibrium, so all material properties are dynamically solicited. For sufficiently long periods, as a rule, the dynamic compressibility k approximates the static compressibility kₛₜₐₜ.

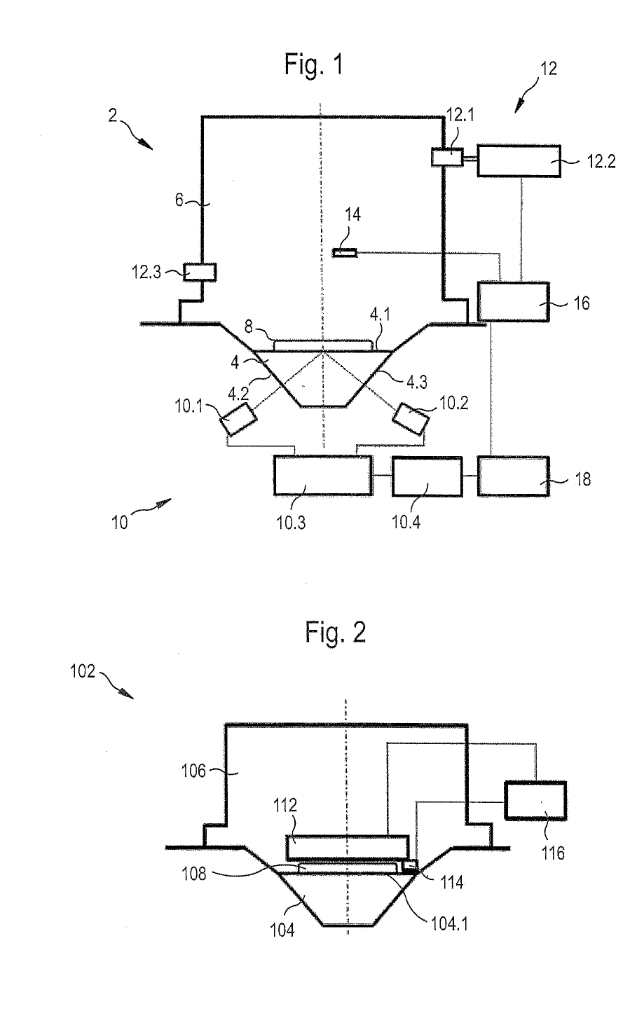

FIG. 2 shows schematically the measuring chamber of a refractometer according to a second embodiment. The reference numerals of the first embodiment are used for the same or the corresponding elements, whereas these numbers are incremented by 100. Reference is therefore made to the description of these elements.

The refractometer 102 of FIG. 2 differs from the refractometer of FIG. 1 in that an ultrasonic transducer 112 is located in the measuring chamber 106. More specifically, the transducer 112 is placed on the sample 108. The transducer generates a high-frequency pressure modulation. A pressure sensor 114 may be provided between the transducer 112 and the measurement surface 104.1 of the measurement prism 104 adjacent to the sample. The pressure sensor 114 is connected to the control unit 116 to control the pressure modulation with regulation.

FIG. 3 shows schematically a refractometer according to a third exemplary embodiment. The reference numerals of the first embodiment are used for the same or the corresponding elements, whereas these numbers are incremented by 200. Reference is therefore made to the description of these elements.

The refractometer of FIG. 3 differs from the refractometer of FIGS. 1 and 2 mainly in that the measuring chamber 206 includes a force control device 212 instead of a pressure control device. The measuring chamber 206 therefore does not need to be sealed. The force control device 212 has a punch 212.1, which preferably extends perpendicularly to the measurement surface of the measuring prism 204, and a first actuator 212.3. The punch 212.1 has a pressure plate 212.2, which forms a contact surface with the sample 208. The actuator 212.3 is located on the end of the punch 212.1 facing away from the sample. The actuator can be designed pneumatically, hydraulically, electrically and/or electro-mechanically. It is preferably a linear actuator which moves the punch 212.1 and the pressure plate 212.2 axially along the longitudinal axis of the punch. The pressure results as a quotient of pressure force and contact surface between punch and sample. Unlike in the realization with gas pressure or sound in this case, the pressure modulation is no longer isotropic but axial.

The force control device 212 may also have a second actuator 212.4. This actuator 212.4 is designed to be able to exert a radial force on the punch 212.1. As a result, an oblique force resulting on the sample can be exerted. Analogously to the first actuator 212.3, the second actuator 212.4 may be designed pneumatically, hydraulically, electrically and/or electromechanically. Such actuators are well known to those skilled in the art and even commercially available. The first actuator 212.3 and optionally the second actuator 212.4 are connected to the control unit 216. The pressure modulation can optionally be performed only with the first actuator 212.3 or only with the second actuator 212.4 or with both actuators.

The actuator or at least one of the actuators may be selected such that it generates directly from its control variable a quantifiable force. The advantage of such actuators is that with a known contact surface, a modulation of the control variable is converted directly into a pressure modulation. If the accuracy requirements are lower, it may then be possible to dispense with a separate force measurement. If the compression deformation is to be modulated instead of the pressure, then the position of the pressure punch can be measured with a suitable sensor 214 and the desired deformation can be readjusted via a control loop.

The actuator or at least one of the actuators can be selected such that it generates directly from its control variable a quantifiable displacement. An example is a spindle or linear motor driven by a step or servo motor. With lower accuracy requirements it can be renounced to a separate displacement measurement. In order to generate a pressure modulation, the force exerted on the sample must be measured with a corresponding sensor 214 and the desired pressure must be readjusted via a control loop or the contact pressure is determined by measuring the displacement with known elastic properties of the materials used.

The sensor 214 may therefore be designed as a force and/or displacement sensor.

In a uniaxial force application, there is a further advantage if, in addition to the refractive index oscillation and the contact pressure, the linear deformation of the sample is also measured. From the contact pressure a and the linear deformation ε of the sample, one then obtains the elastic modulus E via the relation σ=E·ε. For isotropic homogeneous samples we can then determine the Poisson ratio (Poisson Ratio) u via the relation between compressibility and elastic modulus

$$k = \frac{3 ( 1 - 2 υ )}{E}$$

and from data of the dynamic refractive index measurement.

The above equations for compressibility were determined for a pressure modulation. However, they are in principle expandable for other types of modulated mechanical excitation. In this case the formula applies

$$\frac{6 \cdot 〈 n 〉}{( {〈 n 〉}^{2} - 1 ) \cdot ( {〈 n 〉}^{2} + 2 )} \cdot \frac{\partial {n}^{*}}{\partial p} = {( \frac{1}{r} \cdot \frac{\partial r}{\partial p} )}^{*} + {( \frac{1}{ρ} \cdot \frac{\partial ρ}{\partial p} )}^{*}$$

as before, with p as the mechanical excitation variable, but the term

$${( \frac{1}{ρ} \cdot \frac{\partial ρ}{\partial p} )}^{*}$$

no longer interpretable as compressibility. Nevertheless, through the relation to the density, it contains macroscopic information about the sample, while the term

$${( \frac{1}{r} \cdot \frac{\partial r}{\partial p} )}^{*}$$

reflects information about microscopic interactions. Beyond the characterization of a material, in the dynamic quantities

$$\vert \frac{\partial {n}^{*}}{\partial p} \vert or {( \frac{1}{ρ} \cdot \frac{\partial ρ}{\partial p} )}^{*} and \text{/} or {( \frac{1}{r} \cdot \frac{\partial r}{\partial p} )}^{*}$$

temporal changes in a sample are also tracked, e.g. aging processes or chemical reactions such as polymerization reactions.

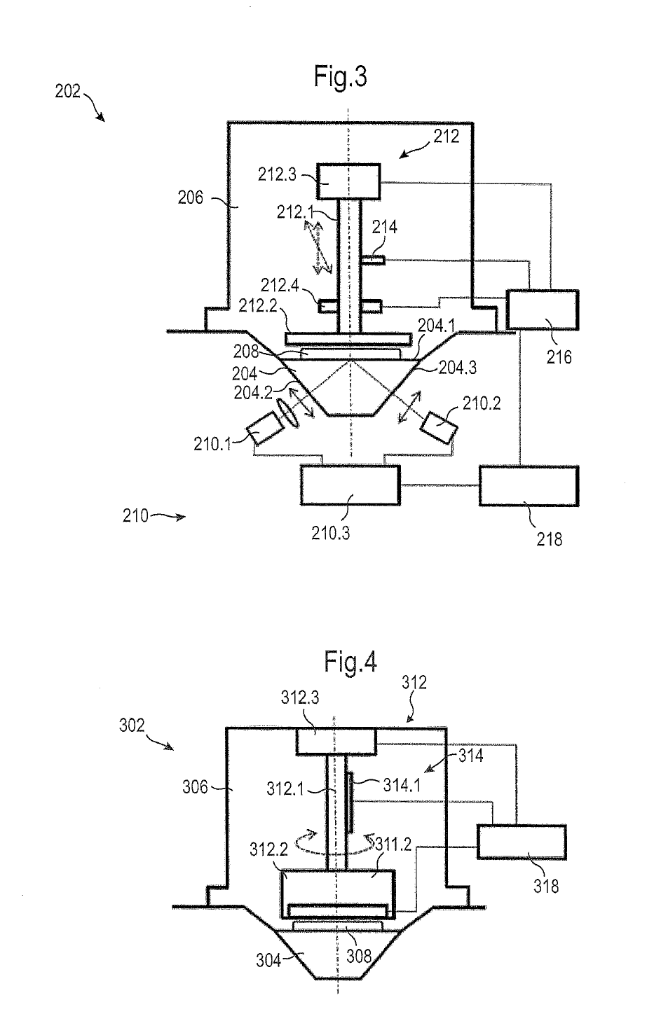

FIG. 4 shows schematically the measuring chamber of a refractometer according to a fourth exemplary embodiment. The reference numerals of the third embodiment are used for the same or the corresponding elements, whereas these numbers are incremented by 100. Reference is therefore made to the description of these elements.

The force control device 312 differs from the force control device of FIG. 3 in that it rotationally stresses the sample 308. This stress causes an oscillating torsion on the sample.

In this design, a gelling transition of a sample can be measured during the polymerization. The gelation point is recognizable as a peak in the imaginary part of the demodulation of the quantities

$$\frac{\partial {n}^{*}}{\partial p} or {( \frac{1}{ρ} \cdot \frac{\partial ρ}{\partial p} )}^{*} and \text{/} or {( \frac{1}{r} \cdot \frac{\partial r}{\partial p} )}^{*} .$$

Since the sample forms a shear strength at the gelling point, a modulated, shearing rotary oscillation is particularly suitable as a stimulus for this type of measurement. In a compressive pressure/force modulation, however, in principle, a signal in the imaginary part of

$$\frac{\partial {n}^{*}}{\partial p} or {( \frac{1}{ρ} \cdot \frac{\partial ρ}{\partial p} )}^{*} and \text{/} or {( \frac{1}{r} \cdot \frac{\partial r}{\partial p} )}^{*}$$

can also be seen.

Further, if the sample temperature T or an equivalent physical or chemical parameter (e.g., humidity, electro-magnetic field, pH) is varied over a known program with continuous pressure/force modulation, phase and glass transitions can also be measured. These manifest as a peak in the phase shift ϕ(T) or in the imaginary part of

$$\frac{\partial {n}^{*}}{\partial p} = \vert \frac{\partial {n}^{*}}{\partial p} \vert {e}^{- i φ} , {( \frac{1}{ρ} \cdot \frac{\partial ρ}{\partial p} )}^{*} and \text{/} or {( \frac{1}{r} \cdot \frac{\partial r}{\partial p} )}^{*} .$$

Depending on the nature of the transition, the peak is not necessarily in the imaginary part of all 3 measures or not in the same place for all three. Thus, a transition may first manifest as a microscopic conformational change before it leads to a macroscopic density change (e.g. protein denaturation). On the other hand, there are transitions that show a macroscopic effect that has little microscopic effect. One such example is the gelling point, which requires fewer individual microscopic bonds to ultimately form the macroscopic unit.

The application of a uniaxial pressure or force modulation can lead to stress birefringence in isotropic samples and the refractive index is to be interpreted in a tensorial manner. Stress birefringence generally applies to the refractive indices of the major axes:

n₁=n_{unloaded}+C₁·σ₁₁+C₂·(σ₂₂+σ₃₃)

n₂=n_{unloeded}+C₁·σ₂₂+C₂·(σ₃₃+σ₁₁)

n₃=n_{unloaded}+C₁·σ₃₃+C₂·(σ₂₂+σ₁₁)

Where n_{unloaded} represents the refractive index of the unloaded sample, C₁ and C₂ represent the stress-optical coefficients and σᵢᵢ represents the normal stresses along the principal axes. If the pressure/force modulation is for example along the x₃-axis, perpendicular to the measuring surface, the refractive index of the ordinary ray n₁=n₂=n₀ is obtained by selecting the s-polarization. When selecting the p-polarization, the refractive index is dependent on the angle of incidence, but it approaches the refractive index of the extraordinary ray n₃=nₐ at the angle of total reflection. The dynamic refractive index measurement outputs directly after demodulation

$${C}_{2} = Re ( \frac{\partial {n}_{0}^{*}}{\partial p} ) = \vert \frac{\partial {n}_{0}^{*}}{\partial p} \vert \cdot cos φ$$

$$and$$

$${C}_{1} = Re ( \frac{\partial {n}_{a}^{*}}{\partial p} ) = \vert \frac{\partial {n}_{a}^{*}}{\partial p} \vert \cdot cos φ .$$

where Re(x) is the real part of a complex quantity x and ϕ is the phase shift between the refractive index and the pressure/force modulation. The difference between the two values

$$Re ( \frac{\partial {n}_{0}^{*}}{\partial p} ) - Re ( \frac{\partial {n}_{a}^{*}}{\partial p} )$$

in turn, represents the photoelastic constant. The dynamic refractive index measurement is therefore suitable for determining stress birefringence of materials.

1.-20. (canceled)

21. A refractometer, comprising:
a measuring body having a measuring surface;
a measuring chamber delimited by the measuring surface of the measuring body for receiving a sample; and
an optical measuring device for measuring the refractive index of the sample by the measuring body;
wherein the measuring chamber is designed for mechanically stressing the sample by a pressure and/or force modulation in order to dynamically measure the refractive index n of the sample during the modulation.

22. The refractometer according to claim 21, wherein the measuring chamber is designed such that the pressure and/or force modulation is oscillating, preferably according to a periodic function.

23. The refractometer according to claim 21, wherein the measuring chamber is gas-tightly lockable, and the refractometer comprises:
a pressure control device for modulating the pressure of a gas in the measuring chamber.

24. The refractometer according to claim 23, wherein the pressure control device includes a first electrically controllable valve, which connects a gas supply with the measuring chamber, and a second electrically controllable valve which connects the measuring chamber to the environment.

25. The refractometer according to claim 23, wherein the pressure control device comprises:
a pressure regulator for modulating the pressure of a gas in the measuring chamber.

26. The refractometer according to claim 21, wherein the measuring chamber comprises:
an ultrasonic transducer for modulating the pressure on the sample.

27. The refractometer according to claim 21, wherein the measuring chamber comprises:
a force and/or feed control device with a punch and at least one actuator for actuating the punch against the sample.

28. The refractometer according to claim 27, wherein the at least one actuator is designed to operate electrically, electro-magnetically, hydraulically and/or pneumatically.

29. The refractometer according to claim 27, wherein the force and/or feed control device comprises:
a sensor for measuring by the force exerted on the sample by the punch and/or a sensor for measuring the displacement of the punch.

30. The refractometer according to claim 27, wherein the force and/or feed control device is designed such that the force exerted by the punch on the sample extends no parallel to the longitudinal axis of the punch.

31. The refractometer according to claim 27, wherein the force control device is configured such that the force exerted on the sample by the punch is rotational about the longitudinal axis of the punch.

32. The refractometer according to claim 21, wherein the refractometer comprises:
an evaluation unit which is designed to determine the compressibility k of the sample, based on the measurement of the refractive index n during the force and/or pressure modulation.

33. A method for measuring properties of a sample, comprising:
introducing the sample into a refractometer;
measuring the refractive index of the sample with the refractometer;
wherein the refractometer comprises:
a measuring body having a measuring surface;
a measuring chamber delimited by the measuring surface of the measuring body for receiving a sample; and
an optical measuring device for measuring the refractive index of the sample by the measuring body;
wherein the measuring chamber is designed for mechanically stressing the sample by a pressure and/or force modulation in order to dynamically measure the refractive index n of the sample during the modulation; and
wherein the sample is stressed by a modulated force and/or a modulated pressure during the measurement of the refractive index, and the refractive index n is dynamically determined as a function of the pressure and/or force modulation.

34. The method according to claim 33, wherein the dynamic compressibility k of the sample is determined from the dynamic refractive, index n using an optomechanical model, preferably the Lorentz-Lorenz equation.

35. The method according to claim 33, wherein the density ρ of the sample is determined during the pressure and/or force modulation on the basis of the displacement or the volume change due to the pressure and/or force modulation.

36. The method according to claim 35, wherein the dynamic specific refractivity r of the sample is determined on the basis of the dynamic refractive index n and the density ρ using an optomechanical model, preferably the Lorentz-Lorenz equation.

37. The method according to claim 36, wherein a chemical reaction, preferably a polymerization reaction, and/or a swelling and/or aging and/or a phase or glass transition during the measurement of the refractive index takes place in the sample, and wherein the change in the dynamic specific refractivity r of the sample provides microscopic information and the change in the density ρ of the sample provides macroscopic information.

38. The method according to claim 33, wherein a gelling transition in the sample takes place during the measurement of the refractive index and the pressure and/or force modulation comprises a modulated shear oscillation and/or a modulated rotational oscillation.

39. The method according to claim 34, wherein one or more signals reflecting the course of the refractive index n, the density ρ, and/or the specific refractivity r are demodulated and a peak in the imaginary part of the demodulation(s) is observed and is correlated with the transition.

40. The method according to claim 33, wherein the optical measuring device selectively emits and/or detects s- and p-polarized rays for measuring anisotropy in the sample.
